(19) United States
(12) Patent Application Publication
(10) Pub. No.: US 2011/0246160 A1
(43) Pub. Date: Oct. 6, 2011

(54) METHOD AND DEVICE FOR DEVELOPMENT AND CERTIFICATION OF TRAINING SIMULATORS FOR AIRCRAFT PILOTING AND RESULTING SIMULATION DEVICE

(75) Inventors: Emmanuel Cloury, Daux (FR); Arnaud Jaupitre, Tournefeuille (FR); Katharyn Wheller, Toulouse (FR)

(73) Assignees: Airbus (S.A.S.), Blagnac Cedex (FR); Airbus Operations (S.A.S.), Toulouse Cedex (FR)

(21) Appl. No.: 13/074,588

(22) Filed: Mar. 29, 2011

(30) Foreign Application Priority Data
Mar. 30, 2010 (FR) 10 52336

(51) Int. Cl. G06G 7/48; G06F 9/44

(52) U.S. Cl. 703/8; 717/120

(57) ABSTRACT

The invention in particular has as an object a method and a device for developing and qualifying a part of the software component of a training simulator for operating a vehicle. Software modules developed for an engineering simulator, modeling the performance of a part of the vehicle, are integrated (400) with a virtualization software application to form a virtual machine that allows the running of these modules in an environment separate from that for which they were developed. Certified (405), the virtual machine may be integrated (435) with other software modules in the training simulator. The training simulator then may be certified (440) without its being necessary to certify the part thereof linked to the virtual machine.

This invention relates to flight simulators for training aircraft pilots and more particularly to a method and a device for development and qualification of training simulators for flying an aircraft as well as the simulation device resulting therefrom.

Generically, a flight simulator is an environment made up of a set of devices and software applications capable of reproducing the performance of an aircraft. There are mainly two types of simulators: engineering simulators and training simulators.

Engineering simulators are used mainly as prototypes during the design of a new aircraft for evaluating and testing new concepts, for fine-tuning on-board equipment items, in particular the various computers, for preparing the first flights as well as for studying the ergonomics of the cockpit and the human factor. These prototypes also may be used during operation of the aircraft for studying modifications of certain characteristics and/or reconstructing sequences having led to an incident.

Apart from the devices for interface with the pilot, the engineering simulators may be purely software or use real equipment items of the aircraft such as control actuators, the communication systems and the electrical systems. The level of complexity of the software part, generally based on a set of modules each intended to model a specific aspect of the aircraft, often varies with the level of development of the aircraft and the nature of the contemplated simulations. Thus, by way of illustration, the module for calculation of the dynamics of the aircraft at first may be intended to model merely the performance of the aircraft, before evolving toward a model fully conforming to the aircraft.

While the training simulators are, in principle, similar to the engineering simulators, there nonetheless are differences linked in particular to their purpose. In fact, these simulators basically are designed to enable pilots to acquire special knowledge about specific aircraft. They generally are produced by independent companies, other than the manufacturers of the aircraft, which upgrade them all along the operation of the corresponding aircraft.

The training simulators are created mainly on the basis of data or specifications provided by the aircraft manufacturers, called data package in English terminology, which define all the necessary features of an aircraft in order to make it possible to simulate its performance.

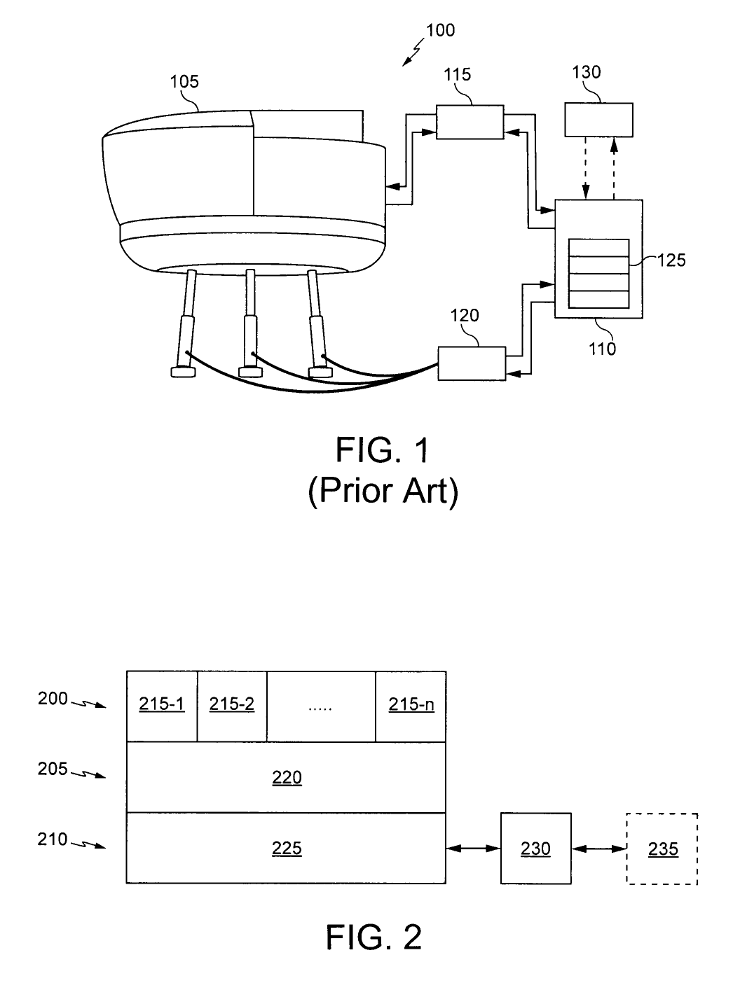

FIG. 1 schematically illustrates an engineering or training simulator 100 comprising in particular a reproduction of cockpit 105 installed on an actuator system in order to reconstruct the forces to which the crew members are subjected in flight. The interior of the reproduction of the cockpit is as close to reality as desired. A panoramic-type screen, allowing a view along an angle of approximately 270°, is installed in front of the reproduction of the cockpit. It allows the display of images, real or synthetic, helping to simulate the visual environment of the pilot.

The reproduction of cockpit 105 is connected to a set of computers 110 implementing the modeling and simulation algorithms via interfaces 115 and 120. Interface 115 here is an interface linked to the display and control devices of the cockpit, for example the control stick, the rudder bars and the electrical contactors, while interface 120 is connected to the mechanisms ensuring the activities of the cockpit.

Computer set 110 comprises various modules 125 used in the simulation, for example a model representing the management and performance of the engines and a model for determination of the dynamic performance of the aircraft.

Real components of the aircraft such as actuators, sensors and/or computers, referenced 130, may be connected to computer set 110.

For obvious safety reasons, the training simulators are qualified by official agencies such as the DGAC (abbreviation for Direction Générale de l'Aviation Civile [Civil Aviation Office]).

Such a qualification may be obtained, however, only when the corresponding aircraft is certified to indicate the full adaptation between the two. A non-negligible period therefore exists between the certification of the aircraft and the availability of the first simulators.

The invention makes it possible to resolve at least one of the problems set forth above.

The invention thus has as an object a method for developing and qualifying at least one part of the software component of a training simulator for operating a vehicle, this method comprising the following steps:
integrating at least one software module developed for an engineering simulator, modeling the performance of at least one part of the said vehicle, with a virtualization software application allowing the running of the said at least one software module in an environment separate from the running environment for which the said at least one module was developed, the integration of the said at least one software module with the said virtualization software application forming a virtual machine; and,
certifying the said virtual machine.

In this way the method according to the invention makes it possible to facilitate and accelerate the development of training simulators on the basis of engineering simulators, without the marked constraint linked to the development environments of the engineering simulators, ensuring a certain perpetuity of the training simulators. The method according to the invention further makes it possible to simplify and accelerate the qualification procedures for training simulators by benefiting from the certification procedures for engineering simulators.

According to a specific embodiment, the said at least one software module comprises a modeling of the dynamic performance of the said vehicle making it possible to simulate the performance of the vehicle at least partially.

The invention also has as an object a method for developing and qualifying at least one part of the software component of a training simulator for operating a vehicle, this method comprising the following steps:
receiving at least one certified virtual machine created according to the method described above, the said at least one software module of the said virtual machine being called first software module;
developing at least one second software module of the said training simulator, separate from the said first software module;
integrating the said at least one virtual machine and the said at least one second software module; and,
qualifying the said at least one part of the software component of the said training simulator.

In this way the method according to the invention makes it possible to combine modules originating from engineering simulators with modules developed specifically for training simulators so as to facilitate the development of training simulators and simplify the qualification procedures.

According to a specific embodiment, the method further comprises a step of receiving specifications, the said at least one second software module being developed according to the said received specifications, so that the said at least one second software module will be in conformity with specifications of the said vehicle. The said at least one software module is, for example, a modeling of at least one part of the said vehicle.

The invention also has as an object a computer program comprising instructions adapted for the implementation of each of the steps of the method described above when the said program is run on a computer as well as a device comprising means adapted for the implementation of each of the steps of the method described above.

The advantages obtained with this computer program and this device are similar to those mentioned above.

The invention also has as an object a device for a training simulator for operating a vehicle, this device comprising the following means,
logic management means adapted for providing a running environment for software applications;
first software means for modeling the performance of at least one first part of the said vehicle, the said first modeling means comprising at least one virtual machine itself comprising at least one first software module for modeling the said performance of the said at least one first part of the said vehicle, the running environment of the said first modeling software means corresponding to the said running environment for software applications and the running environment of the said at least one software module being different from the said running environment for software applications;
second software means comprising at least one second software module adapted for forming an interface between the said training simulator and a user or for modeling the performance of at least one second part of the said vehicle, the running environment of the said at least one second software module corresponding to the said running environment for software applications.

In this way the device according to the invention makes it possible to use training simulators created on the basis of modules specific to training simulators and of modules for engineering simulators, without the marked constraint linked to the development environments of engineering simulators, ensuring a certain perpetuity of the training simulators.

According to a specific embodiment, the said modeling software means comprise software means for modeling the dynamic performance of the vehicle.

Advantageously, the device further comprises calculation and storage means adapted for using the said logic management means.

Other advantages, purposes and characteristics of this invention become apparent from the detailed description that follows, provided by way of non-imitative example, with reference to the attached drawings, in which:

FIG. 1 schematically illustrates an engineering or training simulator;

FIG. 2 schematically illustrates an exemplary architecture of an engineering simulator;

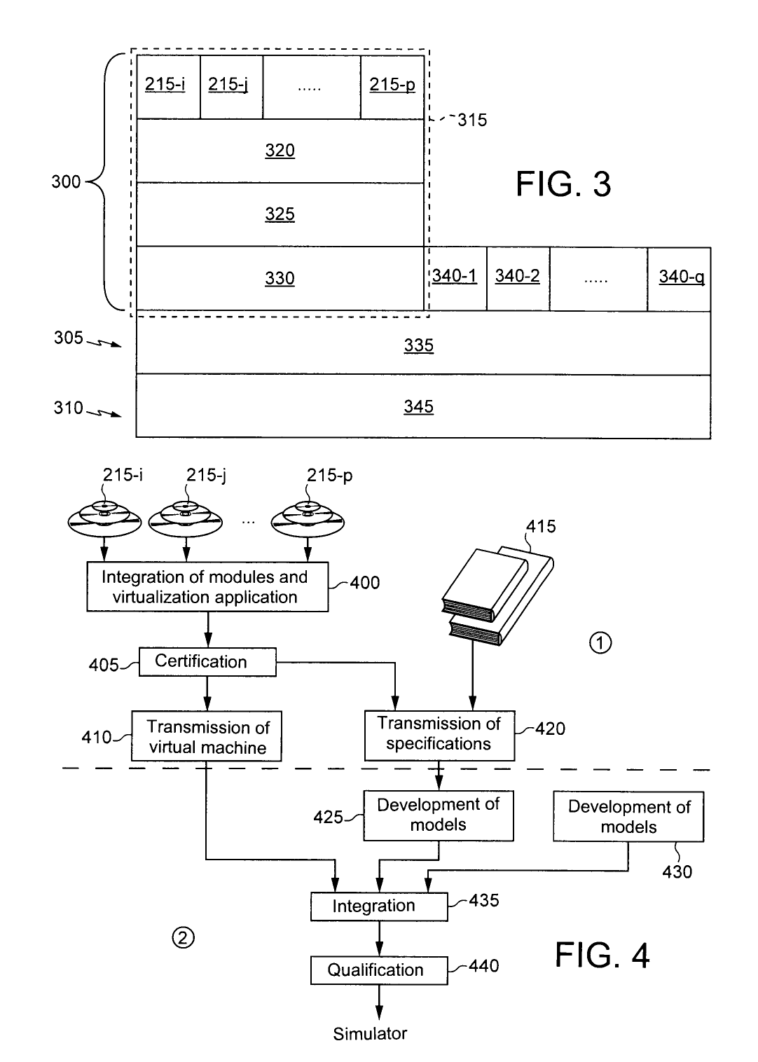

FIG. 3 schematically illustrates an exemplary architecture of a training simulator in accordance with the invention;

FIG. 4 schematically shows an exemplary algorithm that may be used for the development of training simulators; and,

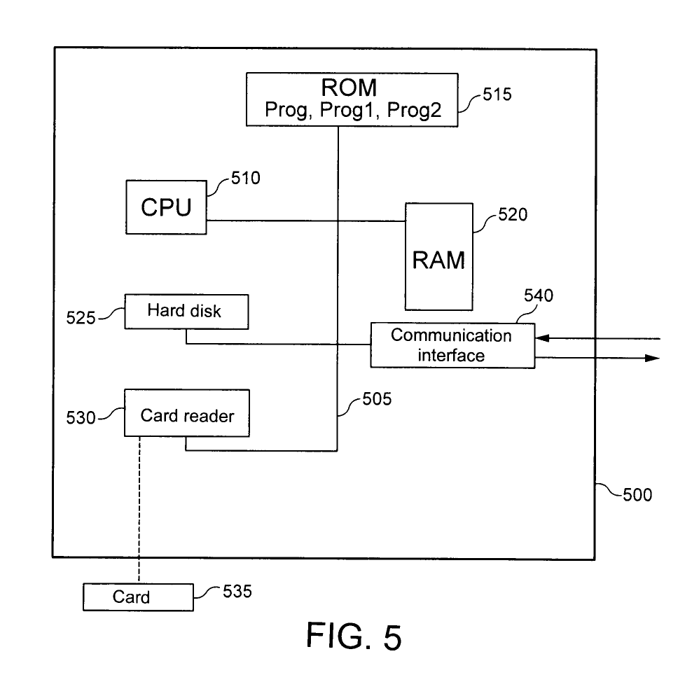

FIG. 5 illustrates an exemplary device adapted for implementing the invention or a part of the invention.

In order to save time on the certification process for an aircraft, manufacturers may obtain certifications on software components or sets of software components used in the engineering simulators, the corresponding parts of the aircraft then being certified through the corresponding software part of the simulator.

Nonetheless, by reason of the sensitivity of the data contained in the software components used in engineering simulators, the aircraft manufacturers do not wish to transfer certified software parts to the producers of training simulators. It therefore is not possible to achieve a migration of certain software parts of an engineering simulator to a training simulator.

It should be recalled here that the development constraints for software modules modeling at least one part of an aircraft and used in the engineering and training simulators are different, in particular by reason of the intended objectives and the operating cycles. A significant difference thus is linked to the systems on which the simulators function and more particularly to the operating systems used.

Thus, in order to limit the time necessary for the qualification of a training simulator without disclosing the know-how of the aircraft manufacturer, the invention applies to the conveyance of certified software modules from engineering simulators to training simulators.

FIG. 2 schematically illustrates an exemplary architecture of an engineering simulator here comprising three layers, an application layer 200, a logic management layer 220 and a hardware layer 210.

The application layer here is made up of different software modules referenced 215-1 to 215-n. The software modules used are, for example, a module for determination of the dynamic performance of the aircraft, a module for determination of the performance of its hydraulic system and a module for determination of the performance of the flight controls. Other modules may be used. The modules also may be changed according to the desired precision of the modeling.

The software modules here represent an executable code the corresponding source code of which is, for example, code C. Each executable code is intended for a specific running environment.

The software modules are used with the aid of a hardware platform represented by hardware layer 210. The latter may be made up of one or more computers or servers connected to each other through a communication network such as an ethernet network. The hardware layer also may comprise specific devices for allowing, in particular, a processing in real time. Moreover, the hardware layer also may comprise expansion peripherals, marked 230, for example input/output cards, to make it possible to connect real components of an aircraft, referenced 235, to the simulation environment.

The application and hardware layers are connected by a logic management layer 205 comprising one or more operating systems referenced 220. The modules used in the application layer are specific to the logic management layer, that is to say to operating system 220.

FIG. 3 schematically illustrates an exemplary architecture of a training simulator in accordance with the invention.

Like the engineering simulator illustrated on FIG. 2, the training simulator here comprises three layers, an application layer 300, a logic management layer 320 and a hardware layer 310.

The application layer comprises a virtual machine 315, preferably provided by an aircraft manufacturer. The virtual machine is an integrated software system comprising simulation software modules developed by the manufacturer of the aircraft, for example modules 215-i to 215-p. As indicated above, these modules may correspond in particular to modeling of the dynamic performance of the aircraft, of its hydraulic system and of the flight controls.

Virtual machine 315 also comprises one or more operating systems 320, compatible with modules 215-i to 215-p.

Virtual machine 315 further comprises a virtualization software application 330 adapted for simulating a hardware layer 325 compatible with operating system or systems 320 and thus with modules 215-i to 215-p.

Virtualization software application 330 is chosen according to operating system or systems 320 as well as according to operating system or systems 335 used in logic management layer 305. By way of illustration, virtualization software application 330 makes it possible to use the Windows operating system (Windows is a trademark) on the Unix operating system (Unix is a trademark). Such a virtualization software program is supplied, for example, by the company VMware (VMware is a trademark).

Furthermore, application layer 300 comprises software modules 340-1 to 340-q developed by the simulator producer. By way of illustration, these modules may be man/machine interface modules, allowing an instructor to create specific flying situations.

Similarly to hardware layer 210 of the engineering simulator illustrated on FIG. 2, hardware layer 310 of the training simulator may comprise one or more computers or servers connected to each other through a communication network such as an Ethernet network. Likewise, the hardware layer also may comprise specific devices to allow, in particular, a processing in real time as well as expansion peripherals (not shown) making it possible to connect real components of the aircraft (not shown) to the simulation environment.

According to a specific embodiment, virtual machine 315 is supplied qualified by the manufacturer of the aircraft with a set of specifications linked to the constraints to be observed with regard to certification. These constraints are linked in particular to the capacities of hardware layer 345.

In this way, certification of the training simulator may be obtained very rapidly, the modules linked to the intrinsic characteristics of the aircraft being integrated and certified beforehand. In other words, the airplane manufacturer supplies to the simulator producer a complete and certified software set for simulation of the aircraft, the producer only having to develop the related software modules.

Moreover, by changing the virtualization software application in order to adapt the virtual machine to new operating systems or to new versions thereof, the aircraft manufacturer may upgrade it without additional development costs and without disclosing the content of the simulation modules.

FIG. 4 schematically shows an exemplary algorithm that may be used for the development of training simulators. The reference (1) here designates the steps implemented by the aircraft manufacturer while the reference (2) designates the steps implemented by the producer of training simulators.

As indicated above with reference to FIG. 3, the aircraft manufacturer generates a virtual machine that may be used directly by the simulator producer. For these purposes, the manufacturer integrates software modules 215-i to 215-p developed for the engineering simulator and to be used in the training simulator with the virtualization software application, (step 400). Again, the virtualization software application is determined according to modules 215-i to 215-p and the operating system or systems used in the training simulator. The virtual machine obtained then is certified (step 405) and transmitted to the simulator producer (step 410).

Similarly, the aircraft manufacturer sends to the simulator producer the specifications for certification of the virtual machine, for example the minimal hardware configuration required, as well as specifications of the aircraft referenced 415 enabling the simulator producer to develop the models it needs, not forming part of the virtual machine (step 420). By way of illustration, such specifications may relate to modeling of the engines of the aircraft.

The simulator producer then is able to develop the simulation models that it needs (step 425). In the same way, before or afterwards, the producer develops the models that it needs, which are not directly linked to the aircraft (step 430), for example training modules enabling an instructor to control certain simulation phases. Alternatively or complementarily, the producer may reuse models developed previously, these models possibly having been developed by it or by a third party.

The virtual machine then is integrated with the other models (step 435) to form the simulator which then may be qualified (step 440) without its being necessary to re-qualify the entire part linked to the virtual machine.

Similarly, the simulator may be based on a plurality of virtual machines originating from different manufacturers. In this way it is possible to integrate a virtual machine intended basically to model the dynamic performance of an aircraft with a virtual machine intended for modeling the engines of this aircraft.

It should be noted here that the models on which the virtual machines are based may not be compatible with each other by reason of the operating systems used, compatibility then resulting from the virtualization software applications used.

A training simulator element for operating a vehicle (for example an aircraft) therefore may comprise at least one first software module for modeling a hardware performance of a least one part of the said vehicle.

For example, the first software module is a module for modeling the dynamic performance of the vehicle, a module for modeling a hydraulic system of the vehicle, a module for modeling controls of the vehicle, or other.

The simulator element furthermore may comprise a virtual machine for running this first module.

In this way, it is possible to run on the simulator software modules developed by the manufacturer of the vehicle during the design phase of the vehicle. For example, these modules are modules that have been certified beforehand.

The element furthermore may be configured for running at least one second software module making it possible to create operating conditions based on the hardware performance modeled by the first software module.

The second software module possibly may not be run by the virtual machine.

Several virtual machines may be provided, for example so that each one runs first modules specific to a respective part of the vehicle. The different virtual machines thus may come from different manufacturers of the respective parts of the vehicle.

The simulator element therefore has a structure allowing the development of a training simulator for operating a vehicle which may reuse software modules already created by the designer of the vehicle without this designer having to disclose all the characteristics and the production secrets of its vehicle.

Furthermore, the certification of a simulator comprising an element such as described is simplified if, for example, the first modules coming from the manufacturer already are certified, for example with the virtual machine. In fact, according to such an example, only the second modules developed by the designer of the simulator remain to be certified. Moreover, this certification does not require the manufacturer of the vehicle to disclose its production secrets.

The simulator element also may take the form of a specific software structure which makes it possible to reuse software modules coming from the design phase of the vehicle and furthermore to separate the modules specific to the simulation and those coming from the design phase of the vehicle.

This structure may be used in a recording medium such as a memory of a simulator, or on another type of data-storage medium on which a data structure defined by the element is recorded.

The simulator element also may be used by a control unit, or a control computer of a simulator.

A device adapted for implementing the invention or a part of the invention is illustrated on FIG. 5. The device shown preferably is a standard device, for example a computer or a server. It is adapted for implementing at least a part of the algorithm for development of a training simulator illustrated on FIG. 4 as well as at least a part of the training simulator.

Device 500 here comprises an internal communication bus 505 to which there are connected:
a central processing unit or microprocessor 510 (CPU, abbreviation for Central Processing Unit in English terminology);
a read-only memory 515 (ROM, acronym for Read Only Memory in English terminology) that can comprise the programs necessary for implementation of the invention;
a random access or cache memory 520 (RAM, acronym for Random Access Memory in English terminology) comprising registers adapted for recording variables and parameters created and modified in the course of running the aforesaid programs;
a communication interface 540 adapted for transmitting and receiving data to and from a communication network, for example a switched-type network.

Device 500 also preferably has the following elements:
a hard disk 525 that can comprise the aforesaid programs and data processed or to be processed according to the invention; and
a memory card reader 530 adapted for receiving a memory card 535 and reading or writing therein data processed or to be processed according to the invention.

The internal communication bus permits communication and interoperability among the various elements included in device 500 or connected thereto. The depiction of the internal bus is not limitative and, in particular, the microprocessor is able to communicate instructions to any element of device 500 directly or via another element of device 500.

The executable code of each program permitting the programmable device to implement the processes according to the invention may be stored, for example, on hard disk 525 or in read-only memory 515.

According to a variant, memory card 535 may contain data, in particular a table of correspondence between the events detected and the commands that may be requested, as well as the executable code of the aforesaid programs which, once read by device 500, is stored on hard disk 525.

According to another variant, the executable code of the programs will be able to be received, at least partially, via first communication interface 540, to be stored in a manner identical to that described above.

More generally, the program or programs will be able to be loaded into one of the storage means of device 500 before being run.

Microprocessor 510 is going to control and direct the running of the instructions or portions of software code of the program or programs according to the invention, which instructions are stored on hard disk 525 or in read-only memory 515 or else in the other aforesaid storage elements. During boot-up, the program or programs that is/are stored in a non-volatile memory, for example hard disk 525 or read-only memory 515, is/are transferred to random access memory 520 which then contains the executable code of the program or programs according to the invention, as well as the registers for storing the variables and parameters necessary for implementation of the invention.

The communication apparatus comprising the device according to the invention also may be a programmed apparatus. This apparatus then contains the code of the computer program or programs for example set into an application-specific integrated circuit, also called ASIC (acronym for Application-Specific Integrated Circuit in English terminology).

Naturally, to satisfy specific needs, an individual competent in the field of the invention will be able to apply modifications in the foregoing description. In particular, the method according to the invention may be applied to the simulation of other types of vehicles, for example to the simulation of automobiles and ships.

1. Method for developing and qualifying at least one part of the software component of a training simulator for operating a vehicle, this method being characterized in that it comprises the following steps,
integrating (400) at least one software module (215) developed for an engineering simulator, modeling the performance of at least one part of the said vehicle, with a virtualization software application (330) allowing the running of at least one software module in an environment separate from the running environment for which the said at least one module was developed, the integration of the said at least one software module with the said virtualization software application forming a virtual machine (315); and,
certifying (405) the said virtual machine.

2. Method according to the preceding claim according to which the said at least one software module comprises a modeling of the dynamic performance of the said vehicle.

3. Method for developing and qualifying at least one part of the software component of a training simulator for operating a vehicle, this method being characterized in that it comprises the following steps,
receiving at least one certified virtual machine formed according to claim 1 or claim 2, the said at least one software module of the said virtual machine being called first software module;
developing (425, 430) at least one second software module (340) of the said training simulator, separate from the said first software module;
integrating (435) the said at least one virtual machine and the said at least one second software module; and,
qualifying (440) the said at least one part of the software component of the said training simulator.

4. Method according to the preceding claim further comprising a step of receiving specifications, the said at least one second software module being developed according to the said received specifications.

5. Method according to the preceding claim according to which the said at least one second software module is a modeling of at least one part of the said vehicle.

6. Computer program comprising instructions adapted for the implementation of each of the steps of the method according to any one of the preceding claims when the said program is run on a computer.

7. Device comprising means adapted for the implementation of each of the steps of the method according to any one of claims 1 to 5.

8. Device for a training simulator for operating a vehicle, this device being characterized in that it comprises the following means,
logic management means adapted for providing a running environment for software applications;
first software means (315) for modeling the performance of at least one first part of the said vehicle, the said first modeling means comprising at least one virtual machine itself comprising at least one first software module for modeling the said performance of the said at least one first part of the said vehicle, the running environment of the said first modeling software means corresponding to the said running environment for software applications and the running environment of the said at least one software module being different from the said running environment for software applications;
second software means (340) comprising at least one second software module adapted for forming an interface between the said training simulator and a user or for modeling the performance of at least one second part of the said vehicle, the running environment of the said at least one second software module corresponding to the said running environment for software applications.

9. Device according to the preceding claim according to which the said modeling software means comprise software means for modeling the dynamic performance of the said vehicle.

10. Device according to claim 8 or claim 9 further comprising calculation and storage means adapted for using the said logic management means.

11. Training simulator element for operating a vehicle, comprising at least one first software module for modeling a hardware performance of at least one part of the said vehicle and a virtual machine for running the said at least one first module, the said element furthermore being configured for running at least one second software module making it possible to create operating conditions on the basis of the hardware performance modeled by the said at least one first software module.

12. Element according to claim 11, in which the said at least one first software module is of one of the following types of modeling modules: module for modeling the dynamic performance of the vehicle, module for modeling a hydraulic system of the vehicle and module for modeling controls of the vehicle.

13. Element according to claim 11, in which the said at least one second software module is not run by the virtual machine.

14. Element according to claim 11, comprising a plurality of virtual machines.

15. Element according to claim 14, in which each virtual machine runs first modules specific to a respective part of the vehicle.
